(19) United States
(12) Patent Application Publication
(10) Pub. No.: US 2026/0046768 A1
(43) Pub. Date: Feb. 12, 2026

(54) Network Power Saving in Split NG-RAN

(71) Applicant: TELEFONAKTIEBOLAGET LM ERICSSON (PUBL), Stockholm (SE)

(72) Inventors: Nianshan Shi, JÄRFÄLLA (SE); Lian Araujo, SOLNA (SE); Sladana Josilo, SOLNA (SE); Sina Maleki, MALMÖ (SE)

(21) Appl. No.: 19/101,047

(22) PCT Filed: Aug. 4, 2023
(86) PCT No.: PCT/IB2023/057923

§ 371 Date: Feb. 4, 2025

Related U.S. Application Data
(60) Provisional application No. 63/370,594, filed on Aug. 5, 2022.

(51) Int. Cl. H04W 52/02; H04W 72/21

(52) U.S. Cl. CPC H04W 52/0235; H04W 72/21

(57) ABSTRACT

According to some embodiments, a method is performed by a wireless device operating with a split next generation radio access network (NG-RAN) architecture. The method comprises transmitting first power saving assistance information to a network node distributed unit (DU) and receiving a configuration from a network node central unit (CU) associated to the network node DU. The configuration is based at least in part on a portion of the first power saving assistance information that the DU forwarded to the CU.

### TECHNICAL FIELD

The present disclosure generally relates to communication networks, and more specifically to network power saving in split next generation radio access network (NG-RAN).

### BACKGROUND

Energy consumption is a considerable challenge of fifth generation (5G) new radio (NR) wireless network systems. The main power consumption comes from the radio unit of the radio access network (RAN) system. The network power consumption for NR is said to be less compared to Long Term Evolution (LTE) because of its lean design. In the current implementation, however, NR will most likely consume more power compared to LTE, e.g., due to the higher bandwidth, and other new performance-enhancing features that contribute to additional energy consumption. Because the network is expected to support a user equipment (UE) with its maximum capability (e.g., throughput, coverage, etc.), the network may need to use full configuration even when maximum network support is actually rarely needed by the UEs. The network needs to know what UE configuration is actually required to avoid full configuration and save energy but provide enough for the needs of the UE.

Third Generation Partnership Project (3GPP) specifications include a UE-based support mechanism, i.e., through UE assistance information (UAI). Using UAI, a UE may send its preference for several radio resource control (RRC) parameters, including parameters related to discontinuous reception (DRX) configuration, bandwidth (BW), the number of serving cells, etc.

The limit on how frequent a UE may send UAI is determined by the prohibit timer set by the network for each UAI item. The network may then configure the UE with the respective configurations whenever possible. The network, however, may also have its own considerations before blindly following a configuration suggested by a UE.

There currently exist certain challenges. For example, 3GPP Rel-18 Network Energy Saving Study Item describes that a UE may provide a full set of parameters that are needed for network power saving. A UE typically has good knowledge about the traffic types and the channel conditions, which can help the network perform power saving configuration, e.g., relax scheduler activation and QoE indicator.

The core network (CN) may also provide information related to UE history information, UE subscription information, and expected UE behavior.

In the NR split architecture, a gNB central unit (gNB-CU) has a control plane connection to a UE via RRC. The gNB-CU also has a control plane connection to an access and mobility management function (AMF) via Next Generation Application Protocol (NGAP). The gNB-CU and gNB distributed unit (gNB-DU) are connected via F1 interface. The gNB-DU is the entity that executes the network power saving techniques. An example is illustrated in FIG. 1.

FIG. 1 is a network diagram illustrating a scenario where a UE provides assistance information related to network power saving via RRC. As illustrated, the gNB-CU receives input from the UE and the AMF. Based on the inputs, the gNB-CU determines network energy saving information and sends it to the gNB-DU. The gNB-DU uses the network energy saving information to perform network energy saving operations.

Solutions are needed to collect the assistance information from different nodes (e.g., AMF, UE), analyze them and convey to the node that executes the power saving techniques.

Similar to the NR split architecture case, solutions are also needed for dual connectivity (DC) and handover. In addition to the entities illustrated in FIG. 1, for DC and handover, the information relevant for power savings may need to be communicated between the master node (MN) and the secondary node (SN), and between the source and target nodes, respectively.

### SUMMARY

As described above, certain challenges currently exist with network power saving in split next generation radio access network (NG-RAN). Certain aspects of the disclosure and their embodiments may provide solutions to these or other challenges. For example, particular embodiments include node coordination related to the user equipment (UE) assistance information (UAI) for network power saving for New Radio (NR) split architecture.

If the UE provides the information via Radio Resource Control (RRC), some of the provided information may be used directly by gNB-DU (e.g., synchronization signal block (SSB) configuration related), while the other information may be processed by the gNB-CU, which sends to the gNB-DU proposals to steer the power saving policy, particularly when it is related to longer sleep. Besides the information provided by the UE, in some embodiments the gNB-CU may use information from the core network (CN), such as UE subscription information, UE expected behavior, etc.

If the UE provides the information via lower layer, e.g., medium access control (MAC) layer, some of the provided information (e.g., SSB configuration), may be used directly by gNB-DU (which hosts the radio link control (RLC)/MAC entity). Other information may be transferred to the gNB-CU, where the gNB-CU performs analysis and may make further proposals to the sending DU, or other DU involved in the UE connection. For dual connectivity (DC), the communication is via Xn interface.

In general, to use the UAI information in network energy saving, in particular embodiments the information is distributed and handled in different network entities, depending on which entities may best use the information and how the UAI is conveyed to the NG-RAN node.

According to some embodiments, a method is performed by a wireless device operating with a split NG-RAN architecture. The method comprises transmitting first power saving assistance information to a network node DU and receiving a configuration from a network node CU associated to the network node DU. The configuration is based at least in part on a portion of the first power saving assistance information that the DU forwarded to the CU.

In particular embodiments, the configuration is further based on information associated with the wireless device received at the CU from a core network node. For example, the information associated with the wireless device may comprise one or more of subscription information associated with the wireless device, an expected behavior associated with the wireless device, and history information associated with the wireless device.

In particular embodiments, the first power saving assistance information comprises any one or more of: a preferred SSB configuration; an indication of semi-statis uplink channel transmissions; an indication of uplink buffer status; a service priority; a delay tolerance; a data rate; a data volume; a traffic type; a time criticality; a packet size; coverage information; mobility status; location information; a preferred discontinuous reception configuration; and a preferred antenna configuration.

In particular embodiments, the method further comprises transmitting second power saving assistance information to the CU and the received configuration is based at least in part on a portion of the first power saving assistance information and the second power saving assistance information. In particular embodiments, the first power saving assistance information comprises any one or more of: a preferred SSB configuration; an indication of semi-statis uplink channel transmissions; an indication of uplink buffer status; a preferred antenna configuration. The second power saving assistance information may comprise any one or more of: a service priority; a delay tolerance; a data rate; a data volume; a traffic type; a time criticality; a packet size; coverage information; mobility status; location information; and a preferred discontinuous reception configuration.

In particular embodiments, the first power saving assistance information is sent to the DU via MAC layer. The second power saving assistance information may be sent to the CU via RRC.

According to some embodiments, a wireless device comprises processing circuitry operable to perform any of the wireless device methods described above.

Also disclosed is a computer program product comprising a non-transitory computer readable medium storing computer readable program code, the computer readable program code operable, when executed by processing circuitry to perform any of the methods performed by the wireless devices described above.

According to some embodiments, a method is performed by a network node CU operating with a split NG-RAN architecture. The method comprises: receiving first power saving assistance information associated with a first wireless device from a network node DU associated with the first wireless device: determining a power saving configuration for the network based at least in part on the first power saving assistance information; and transmitting the power saving configuration to the DU.

In particular embodiments, the method further comprises receiving information associated with the first wireless device from a core network node and determining the power saving configuration is further based on the information associated with the first wireless device received from the core network node.

In particular embodiments, the method further comprises receiving second power saving assistance information from the first wireless device and determining the power saving configuration is further based on the second power saving assistance information.

In particular embodiments, the second power saving assistance information is received via RRC.

In particular embodiments, the method further comprises receiving third power saving assistance information from a second wireless device and determining the power saving configuration is further based on the third power saving assistance information.

According to some embodiments, a method is performed by a network node DU operating with a split NG-RAN architecture. The method comprises: receiving first power saving assistance information associated with a first wireless device from the first wireless device; transmitting a portion of the first power saving assistance information to a network node CU; and receiving from the CU a power saving configuration for the network based at least in part on the first power saving assistance information.

In particular embodiments, the power saving configuration is further based on information associated with the first wireless device received from a core network node.

In particular embodiments, the first power saving assistance information is received via MAC layer.

According to some embodiments, a network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network nodes described above.

Certain embodiments may provide one or more of the following technical advantages. For example, in particular embodiments the network may acquire additional information from a UE to make several network adjustments such as time to sleep, reduced carrier power, multiple-input multiple-output (MIMO) sleep, or even carrier deactivation, which results in network power-saving, without compromising the UE performance, C-DRX/DRX adaptation, and network DTRX determination.

### BRIEF DESCRIPTION OF THE DRAWINGS

The present disclosure may be best understood by way of example with reference to the following description and accompanying drawings that are used to illustrate embodiments of the present disclosure. In the drawings:

FIG. 1 is a network diagram illustrating a scenario where a user equipment (UE) provides assistance information related to network power saving via Radio Resource Control (RRC);

FIG. 2 is a network diagram illustrating a scenario where a UE provides assistance information related to network power saving via medium access control (MAC) layer;

FIG. 3 is a network diagram illustrating a scenario where a UE provides assistance information related to network power saving via Radio Resource Control (RRC) and MAC layer;

FIG. 4 shows an example of a communication system, according to certain embodiments:

FIG. 5 shows a user equipment (UE), according to certain embodiments:

FIG. 6 shows a network node, according to certain embodiments:

FIG. 7 is a block diagram of a host, according to certain embodiments:

FIG. 8 is a block diagram illustrating a virtualization environment in which functions implemented by some embodiments may be virtualized:

FIG. 9 shows a communication diagram of a host communicating via a network node with a UE over a partially wireless connection in accordance with some embodiments:

FIG. 10 is a flowchart illustrating an example method in a wireless device, according to certain embodiments:

FIG. 11A is a flowchart illustrating an example method in a network node central unit (CU), according to certain embodiments; and

FIG. 11B is a flowchart illustrating an example method in a network node distributed unit (DU), according to certain embodiments.

### DETAILED DESCRIPTION

As described above, certain challenges currently exist with network power saving in split next generation radio access network (NG-RAN). Certain aspects of the disclosure and their embodiments may provide solutions to these or other challenges. For example, particular embodiments include node coordination related to the user equipment (UE) assistance information (UAI) for network power saving for New Radio (NR) split architecture.

Particular embodiments are described more fully with reference to the accompanying drawings. Embodiments are provided by way of example to convey the scope of the subject matter to those skilled in the art.

The assistance information from the UE concerning the network energy savings may be reported to the network in different ways. When received, the assistance information may be used and processed in different nodes in the network.

In some embodiments, a UE reports the assistance information via Radio Resource Control (RRC) to a gNB-CU. Some of the information, such as preferred synchronization signal block (SSB) configurations, indication of semi-static uplink channel transmissions, and indication of UE buffer status for uplink channel transmissions, are used by gNB-DU and may be included in the existing RRC container.

For other information, such as UE traffic information (e.g., service priority, delay tolerance, data rate, data volume, traffic type, time criticality, packet size(s), coverage, mobility status, location, etc.), even if they could be included in the RRC container, the gNB-DU does not have enough knowledge to use them. For the latter type of the assistance information provided by the UE, the gNB-CU may analyze and propose to the gNB-DU the most adequate energy saving policy.

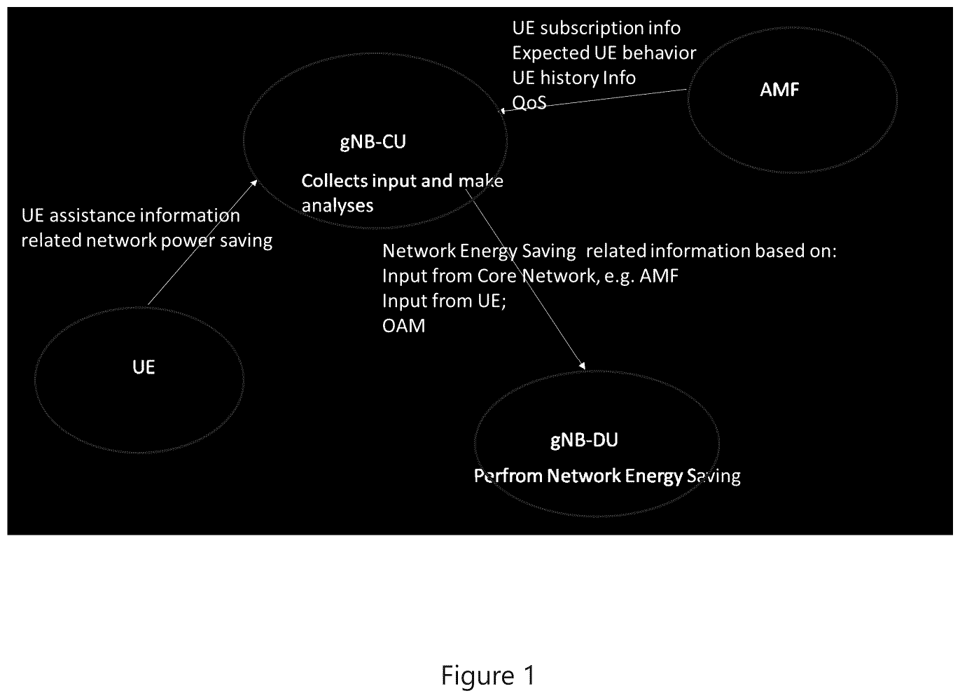

In a similar fashion, e.g., the UE may provide, in addition to above assistance information or alone, a preference for C-DRX. In this case, even though the gNB-DU may end up being one of the possibilities to perform the adaptation (e.g., through L1/L2 signaling), gNB-CU is better positioned to determine the C-DRX configuration because the gNB-CU has access to the information of other UEs as well as information about multiple cells. The choice of policy in this case is based on the information exchanged between multiple entities, as illustrated in FIG. 1.

In some embodiments, a UE reports the assistance information via lower layer, e.g., medium access control (MAC) layer, which resides in gNB-DU. The gNB-DU may use some information directly, and pass some information to the gNB-CU. Upon reception of the information, the gNB-CU may process and propose to the gNB-DU the most adequate energy saving policy.

The gNB-CU may collect information from different gNB-DU involved in the UE connection and decide based on the information collected from multiple sources. For example, the UE may provide a preference for increasing scheduling request (SR) periodicity when the UE has or expects more uplink data. In this case, the UE may provide the assistance information through lower layers to the gNB-DU, and the gNB-DU can decide to grant the UE request, or transmit it to gNB-CU for further processing before changing the UE SR configuration.

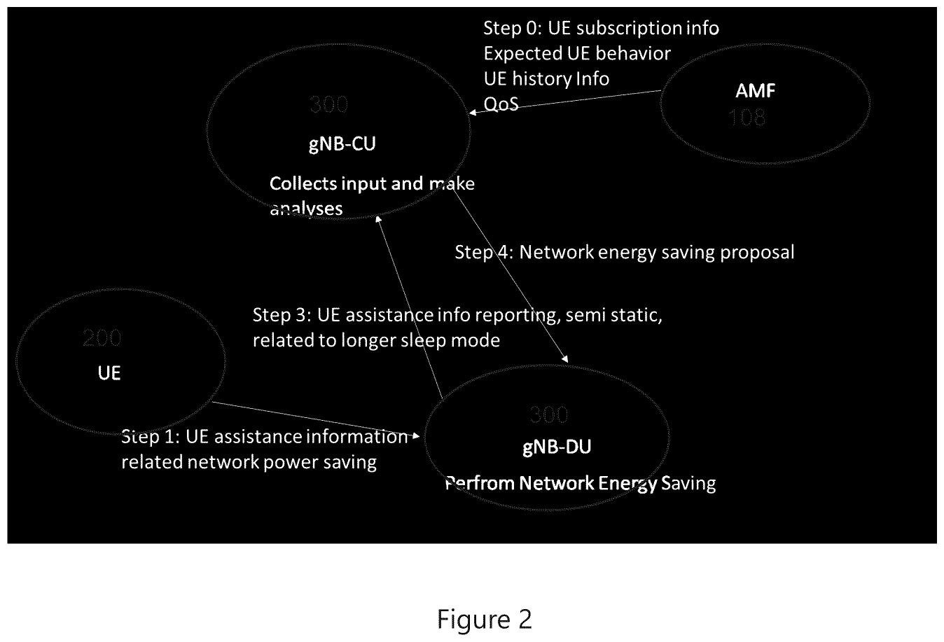

In another example, the UE may provide a preference for antenna configuration to the network, or a preference for a number of antenna ports, or TXRX RUs, or even antenna elements. Such assistance information may be provided on a more dynamic way through, e.g., MAC layer to the gNB-DU, and then the gNB-DU can transmit this to the gNB-CU for further processing considering that a change in antenna configurations impacts multiple UEs and even multiple cells (see FIG. 2).

FIG. 2 is a network diagram illustrating a scenario where a UE provides assistance information related to network power saving via MAC layer. At step 0, gNB-CU 300 receives UE subscription information, UE expected behavior, and/or UE history information from access and mobility management function (AMF) 108. At step 1, UE 200 sends assistance information related to network power saving to gNB-DU 300 via the MAC layer. gNB-DU 300 may use some of the assistance information itself and gNB-DU 300 may forward some of the assistance information to gNB-CU 300. gNB-CU 300 may use the forwarded assistance information, alone or in combination with the information received from AMF 108 at step 0, to determine a network energy saving proposal. gNB-CU 300 then forwards the energy saving proposal to gNB-DU 300.

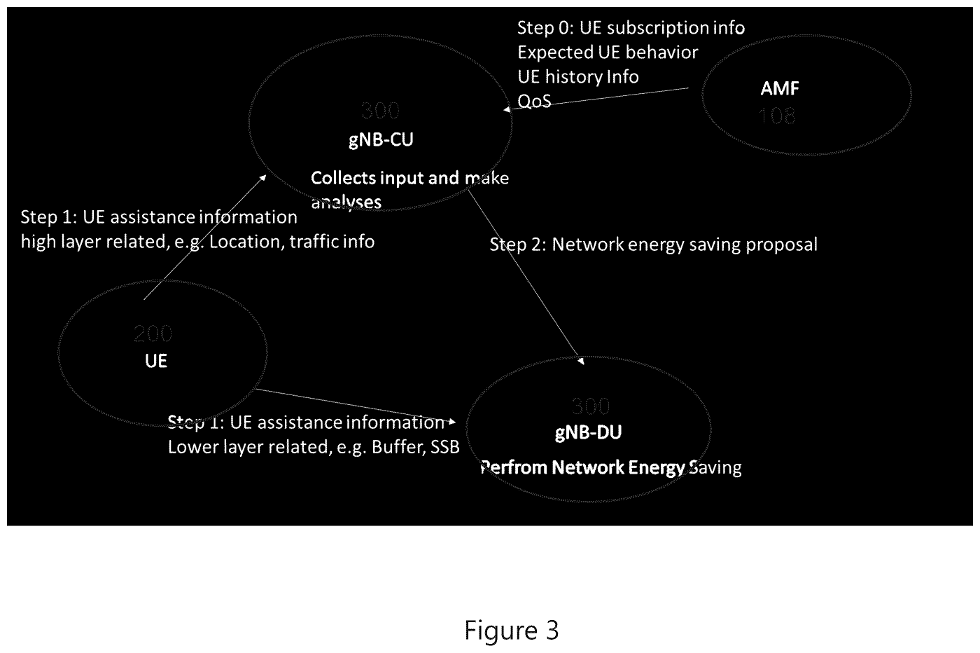

In some embodiments, a UE reports dynamic assistance information, such as SSB configuration, buffer state via lower layer, e.g., MAC layer, so that the gNB-DU may use them in a timely manner. The UE reports other semi static information, e.g., traffic information, service priority, and location to the gNB-CU, because this type of information should be processed first by gNB-CU. Upon reception of the information, the gNB-CU processes and sends a proposal to the gNB-DU related to energy saving policy (see FIG. 3).

FIG. 3 is a network diagram illustrating a scenario where a UE provides assistance information related to network power saving via RRC and MAC layer. The steps in FIG. 2 are similar to those in FIG. 2, except that, as described above, UE 200 may send some assistance information directly to gNB-DU 300 via MAC layer and some assistance information to gNB-CU 300 via RRC.

In one example, the gNB-CU can additionally indicate to the gNB-DU the type of assistance information that the gNB-CU would be interested in receiving from the gNB-DU, or alternatively, indicate to the gNB-DU the actions that the GNB-DU can take directly without consulting with the gNB-CU.

In some embodiments, the gNB-CU collects the information from a group of UEs and makes the proposal to the gNB-DU or a neighbor gNB. For example, a group of UEs may transmit an assistance information regarding SSB configuration in one or more cells, and the gNB-CU may decide to reconfigure the SSB configuration of those cells or other cells based on the received information, and furthermore inform the neighbor gNBs such that they can communicate the new SSB configuration to the UEs within their coverage.

For a UE configured with dual connectivity (DC), different types of assistance information may be sent to different nodes. When the assistance information is master node (MN) specific, the UE may send assistance information directly to the MN. When the assistance information is secondary node (SN) specific, the UE may send the assistance information directly to the SN. For more general assistance information (i.e., that is not MN or SN specific), the UE may send it to both MN and SN, or to one of them and then the MN and SN may convey the information between each other.

For more general assistance information (i.e., that is not MN or SN specific), the UE may send it to the MN only. Based on its local knowledge, the MN can decide whether to forward the received assistance information to the SN. The MN can decide to forward only parts or the whole content of the assistance information provided by the UE.

For handover, the source MN forwards the latest assistance information from the UE to the target MN. When the handover involves SN change as well, the source SN forwards the latest assistance information from the UE to the target SN.

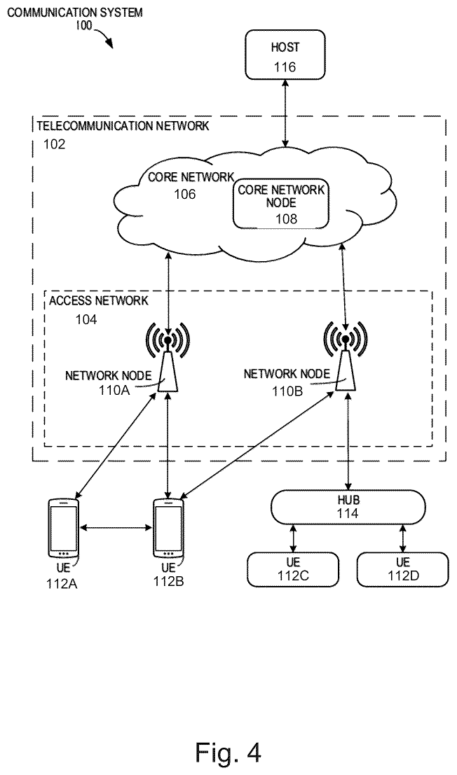

FIG. 4 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM): Universal Mobile Telecommunications System (UMTS): Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

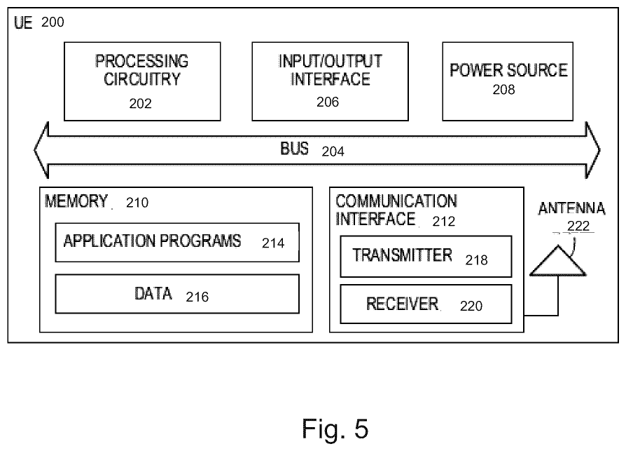

FIG. 5 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware: one or more stored computer programs, general-purpose processors, such as a microprocessor or digital signal processor (DSP), together with appropriate software: or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

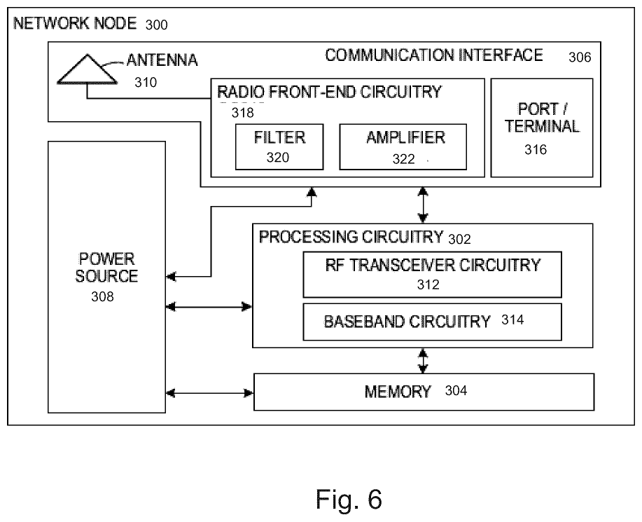

FIG. 6 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 6 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

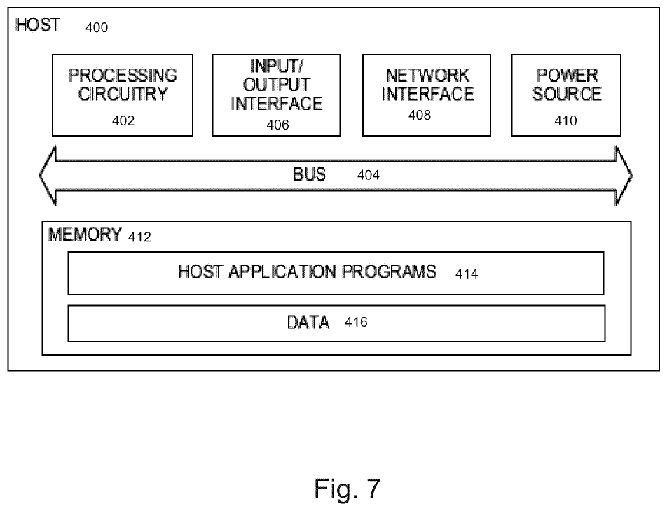

FIG. 7 is a block diagram of a host 400, which may be an embodiment of the host 116 of FIG. 1, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

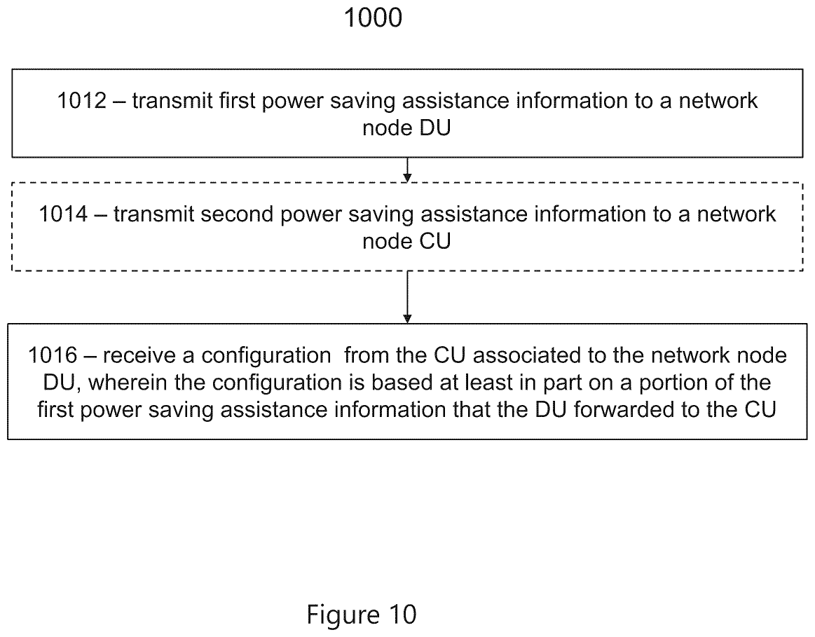

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 10 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

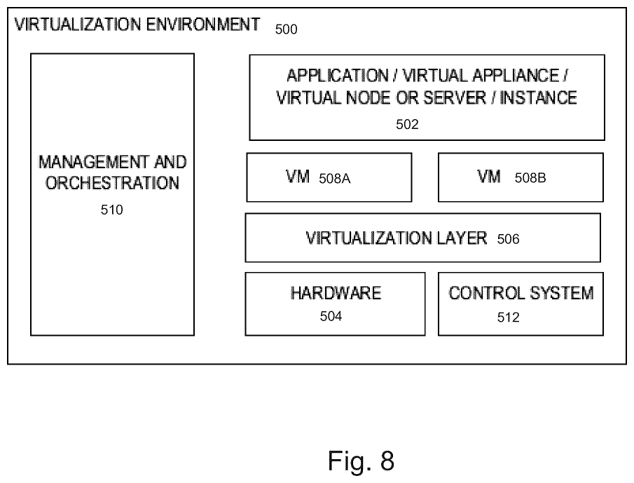

FIG. 8 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

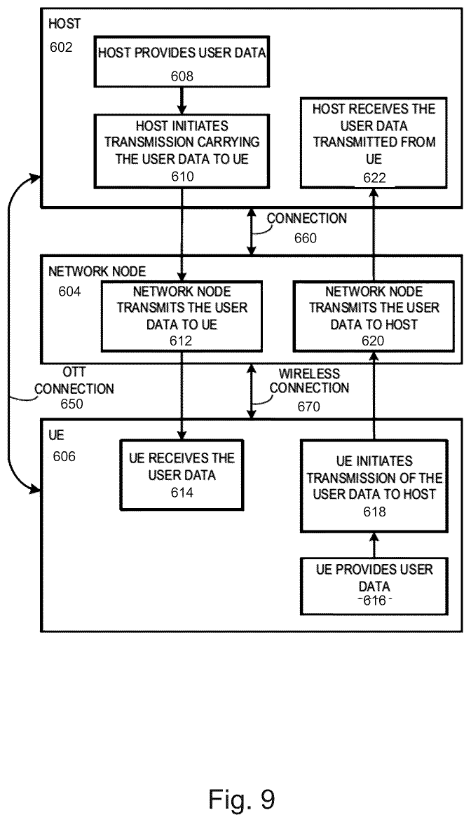

FIG. 9 shows a communication diagram of a host 602 communicating via a network node 604 with a UE 606 over a partially wireless connection in accordance with some embodiments. Example implementations, in accordance with various embodiments, of the UE (such as a UE 112a of FIG. 4 and/or UE 200 of FIG. 2), network node (such as network node 110a of FIG. 4 and/or network node 300 of FIG. 3), and host (such as host 116 of FIG. 4 and/or host 400 of FIG. 4) discussed in the preceding paragraphs will now be described with reference to FIG. 6.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 1) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the data rate and latency and thereby provide benefits such as reduced user waiting time, better responsiveness, and better QoE.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes: the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.: the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy” messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

FIG. 10 is a flowchart illustrating an example method in a wireless device, according to certain embodiments. In particular embodiments, one or more steps of FIG. 10 may be performed by UE 200 described with respect to FIG. 5. The wireless device is capable of operating with a split NG-RAN architecture.

The method begins at step 1012, where the wireless device (e.g., UE 200) transmits first power saving assistance information to a network node DU. The wireless device may transmit the first power saving assistance information via MAC layer.

In particular embodiments, the first power saving assistance information comprises any one or more of: a preferred SSB configuration; an indication of semi-statis uplink channel transmissions; an indication of uplink buffer status; a service priority; a delay tolerance; a data rate; a data volume; a traffic type; a time criticality; a packet size; coverage information; mobility status; location information; a preferred discontinuous reception configuration; and a preferred antenna configuration. The first power saving assistance information may comprise any of the assistance information described with respect to the embodiments and examples described above.

In some embodiments, as described on more detail above, the wireless device may send some power saving assistance information directly to the CU. In these embodiments, at step 1014, the wireless device may transmit second power saving assistance information to the CU. The second power saving assistance information may be sent to the CU via RRC.

In these embodiments, the first power saving assistance information comprises any one or more of: a preferred SSB configuration; an indication of semi-statis uplink channel transmissions; an indication of uplink buffer status; a preferred antenna configuration. The second power saving assistance information may comprise any one or more of: a service priority; a delay tolerance; a data rate; a data volume: a traffic type; a time criticality; a packet size; coverage information; mobility status; location information; and a preferred discontinuous reception configuration. In particular embodiments the first and second power saving assistance information may comprise any of the assistance information described with respect to the embodiments and examples described above.

A step 1016, the wireless device receives a configuration from a network node CU associated to the network node DU. The configuration is based at least in part on a portion of the first power saving assistance information that the DU forwarded to the CU (for the embodiments where the DU forwards power saving assistance information to the CU). The configuration may also be based at least in part on a portion of the first power saving assistance information and the second power saving assistance information sent to the CU by the wireless device. In some embodiments, the DU may not forward any power saving assistance information to the CU when the wireless device also sends power saving assistance information to the CU. In other embodiments, the wireless device may send power saving assistance information to the CU and the DU may also forward power saving assistance information to the CU.

In particular embodiments, the configuration is further based on information associated with the wireless device received at the CU from a core network node. For example, the information associated with the wireless device may comprise one or more of subscription information associated with the wireless device, an expected behavior associated with the wireless device, and history information associated with the wireless device.

As described in more detail above, the CU aggregates all the information from the various sources to determine a power saving network configuration. The CU may configure the DU and/or the wireless device according to the power saving configuration. Thus, receiving the configuration from the network node CU may refer to receiving particular configuration information from the network node CU, or may refer to receiving a configuration from the network node DU based on the DU being configured for power saving by the CU. For example, receiving the configuration may comprise receiving an updated SSB config, DRX config, etc. In particular embodiments, receiving the configuration comprises receiving any of the power saving configurations described with respect to the embodiments and examples described above.

Modifications, additions, or omissions may be made to method 1000 of FIG. 10. Additionally, one or more steps in the method of FIG. 10 may be performed in parallel or in any suitable order.

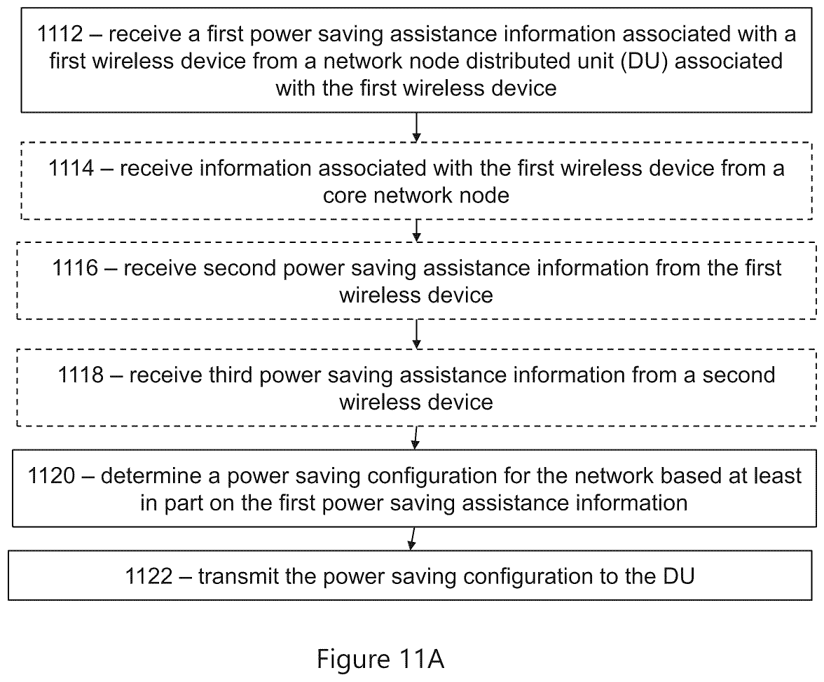

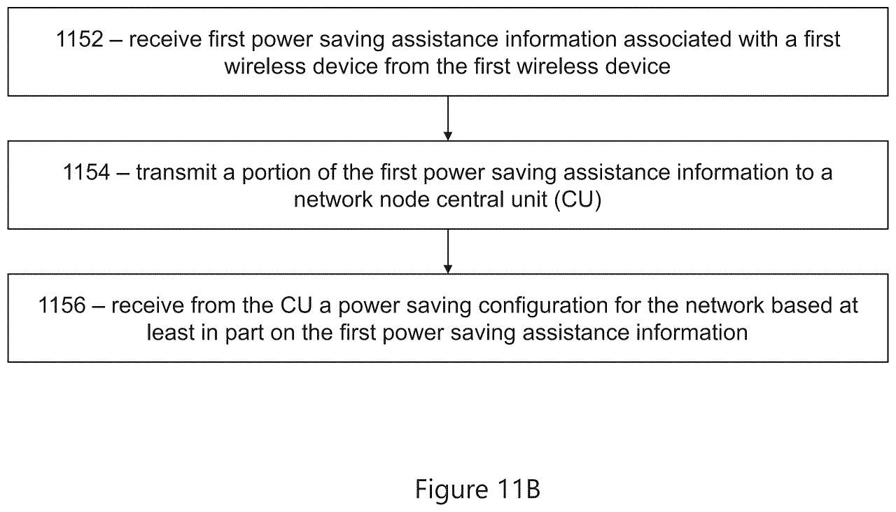

FIG. 11A is a flowchart illustrating an example method in a network node central unit (CU), according to certain embodiments. In particular embodiments, one or more steps of FIG. 11A may be performed by network node 300 described with respect to FIG. 6. The network node CU is capable of operating with a split NG-RAN architecture.

The method begins at step 1112, where the network node (e.g., network node 300) receiving first power saving assistance information associated with a first wireless device from a network node DU associated with the first wireless device. The first power saving information is described in more detail above with respect to FIG. 10.

At step 1114, the network node CU receives information associated with the first wireless device from a core network node. The information received from the core network node is described in more detail above with respect to FIG. 10.

At step 1116, the network node CU receives (e.g., via RRC) second power saving assistance information from the first wireless device. The second power saving assistance information is described in more detail above with respect to FIG. 10.

At step 1118, the network node CU receives third power saving assistance information from a second wireless device. For example, the CU may receive power saving assistance information from any number of wireless devices and or DUs.

At step 1120, the network node CU determines a power saving configuration for the network based at least in part on the first power saving assistance information (for embodiments where the DU forwards power saving assistance information to the CU) and one or more of the information associated with the first wireless device received from the core network nod, the second power saving assistance information, and/or the third power saving assistance information. In particular embodiments the network node CU determines a power saving configuration according to any of the embodiments and examples described above.

At step 1122, the network node CU transmits the power saving configuration to the DU. The power saving configuration may comprise a plurality of configurations for features such as SSB, discontinuous reception, etc. The power saving configuration may comprise any of the power saving configurations described with respect to the embodiments and examples described herein.

Modifications, additions, or omissions may be made to method 1100 of FIG. 11A. Additionally, one or more steps in the method of FIG. 11A may be performed in parallel or in any suitable order.

FIG. 11B is a flowchart illustrating an example method in a network node distributed unit (DU), according to certain embodiments. In particular embodiments, one or more steps of FIG. 11B may be performed by network node 300 described with respect to FIG. 6. The network node is capable of operating with a split NG-RAN architecture.

The method begins at step 1152, where the network node (e.g., network node 300) receives (e.g., via MAC layer) first power saving assistance information associated with a first wireless device from the first wireless device. The first power saving assistance information is described in more detail above with respect to FIG. 10.

At step 1154, the network node DU transmits a portion of the first power saving assistance information to a network node CU.

At step 1156, the network node DU receives from the CU a power saving configuration for the network based at least in part on the first power saving assistance information. In particular embodiments, the power saving configuration is further based on information associated with the first wireless device received from a core network node. The power saving configuration is described above with respect to FIGS. 10 and 11A.

Modifications, additions, or omissions may be made to method 1150 of FIG. 11B. Additionally, one or more steps in the method of FIG. 11B may be performed in parallel or in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

Some example embodiments are described below.

### Group A Embodiments

1. A method performed by a wireless device operating with a split next generation radio access network (NG-RAN) architecture, the method comprising:
   transmitting power saving assistance information to a gNB-DU; and
   receiving a configuration from a gNB-CU associated to the gNB-DU, wherein the configuration is based at least in part on the power saving assistance information.
2. The method of the previous embodiment, wherein the configuration is further based on I information received at the gNB-CU from a core network node.
3. A method performed by a wireless device, the method comprising:
   any of the wireless device steps, features, or functions described above, either alone or in combination with other steps, features, or functions described above.
4. The method of the previous embodiment, further comprising one or more additional wireless device steps, features or functions described above.
5. The method of any of the previous embodiments, further comprising:
   providing user data; and
   forwarding the user data to a host computer via the transmission to the base station.

### Group B Embodiments

6. A method performed by a base station operating with a split next generation radio access network (NG-RAN) architecture, the method comprising:
   receiving, at a gNB-DU, power saving assistance information from a wireless device;
   transmitting at least part of the power saving assistance information to a gNB-CU associated to the gNB-DU; and
   receiving a configuration from the gNB-CU, wherein the configuration is based at least in part on the power saving assistance information.
7. The method of the previous embodiment, further comprising transmitting the configuration to the wireless device.
8. A method performed by a base station operating with a split next generation radio access network (NG-RAN) architecture, the method comprising:
   receiving, at a gNB-CU, power saving assistance information from a wireless device;
   determining a configuration for the wireless device based at least in part on the power saving assistance information; and
   transmitting the configuration to the wireless device.
9. A method performed by a base station, the method comprising:
   any of the steps, features, or functions described above with respect to base station, either alone or in combination with other steps, features, or functions described above.
10. The method of the previous embodiment, further comprising one or more additional base station steps, features or functions described above.
11. The method of any of the previous embodiments, further comprising:
   obtaining user data; and
   forwarding the user data to a host computer or a wireless device.

### Group C Embodiments

12. A mobile terminal comprising:
   processing circuitry configured to perform any of the steps of any of the Group A embodiments; and
   power supply circuitry configured to supply power to the wireless device.
13. A base station comprising:
   processing circuitry configured to perform any of the steps of any of the Group B embodiments;
   power supply circuitry configured to supply power to the wireless device.
14. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
15. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
16. The communication system of the pervious embodiment further including the base station.
17. The communication system of the previous 2 embodiments, further including the UE, wherein the UE is configured to communicate with the base station.
18. The communication system of the previous 3 embodiments, wherein:
   the processing circuitry of the host computer is configured to execute a host application, thereby providing the user data; and
   the UE comprises processing circuitry configured to execute a client application associated with the host application.
19. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
20. The method of the previous embodiment, further comprising, at the base station, transmitting the user data.
21. The method of the previous 2 embodiments, wherein the user data is provided at the host computer by executing a host application, the method further comprising, at the UE, executing a client application associated with the host application.
22. A user equipment (UE) configured to communicate with a base station, the UE comprising a radio interface and processing circuitry configured to performs any of the previous 3 embodiments.
23. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
24. The communication system of the previous embodiment, wherein the cellular network further includes a base station configured to communicate with the UE.
25. The communication system of the previous 2 embodiments, wherein:
   the processing circuitry of the host computer is configured to execute a host application, thereby providing the user data; and
   the UE's processing circuitry is configured to execute a client application associated with the host application.
26. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
27. The method of the previous embodiment, further comprising at the UE, receiving the user data from the base station.
28. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
29. The communication system of the previous embodiment, further including the UE.
30. The communication system of the previous 2 embodiments, further including the base station, wherein the base station comprises a radio interface configured to communicate with the UE and a communication interface configured to forward to the host computer the user data carried by a transmission from the UE to the base station.
31. The communication system of the previous 3 embodiments, wherein:
   the processing circuitry of the host computer is configured to execute a host application; and
   the UE's processing circuitry is configured to execute a client application associated with the host application, thereby providing the user data.
32. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
33. A method implemented in a communication system including a host computer, a base station and a user equipment (UE), the method comprising:
   at the host computer, receiving user data transmitted to the base station from the UE, wherein the UE performs any of the steps of any of the Group A embodiments.
34. The method of the previous embodiment, further comprising, at the UE, providing the user data to the base station.
35. The method of the previous 2 embodiments, further comprising:
   at the UE, executing a client application, thereby providing the user data to be transmitted; and
   at the host computer, executing a host application associated with the client application.
36. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
37. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
38. The communication system of the previous embodiment further including the base station.
39. The communication system of the previous 2 embodiments, further including the UE, wherein the UE is configured to communicate with the base station.
40. The communication system of the previous 3 embodiments, wherein:
   the processing circuitry of the host computer is configured to execute a host application;
   the UE is configured to execute a client application associated with the host application, thereby providing the user data to be received by the host computer.
41. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
42. The method of the previous embodiment, further comprising at the base station, receiving the user data from the UE.
43. The method of the previous 2 embodiments, further comprising at the base station, initiating a transmission of the received user data to the host computer.

1. A method performed by a wireless device operating with a split next generation radio access network (NG-RAN) architecture, the method comprising:
transmitting first power saving assistance information to a network node distributed unit (DU);
receiving a configuration from a network node central unit (CU) associated to the network node DU, wherein the configuration is based at least in part on a portion of the first power saving assistance information that the DU forwarded to the CU.

2. The method of claim 1, wherein the configuration is further based on information associated with the wireless device received at the CU from a core network node.

3. The method of claim 2, wherein the information associated with the wireless device comprises one or more of subscription information associated with the wireless device, an expected behavior associated with the wireless device, and history information associated with the wireless device.

4. The method of claim 1, wherein the first power saving assistance information comprises any one or more of:
a preferred synchronization signal block (SSB) configuration;
an indication of semi-statis uplink channel transmissions;
an indication of uplink buffer status;
a service priority;
a delay tolerance;
a data rate;
a data volume;
a traffic type;
a time criticality;
a packet size;
coverage information;
mobility status;
location information;
a preferred discontinuous reception configuration; and
a preferred antenna configuration.

5. The method of claim 1, further comprising transmitting second power saving assistance information to the CU, and wherein the received configuration is based at least in part on a portion of the first power saving assistance information and the second power saving assistance information.

6. The method of claim 5, wherein:
the first power saving assistance information comprises any one or more of:
a preferred synchronization signal block (SSB) configuration;
an indication of semi-statis uplink channel transmissions;
an indication of uplink buffer status;
a preferred antenna configuration; and
the second power saving assistance information comprises any one or more of:
a service priority;
a delay tolerance;
a data rate;
a data volume;
a traffic type;
a time criticality;
a packet size;
coverage information;
mobility status;
location information; and
a preferred discontinuous reception configuration.

7.-8. (canceled)

9. A wireless device configured to operate with a split next generation radio access network (NG-RAN) architecture, the wireless device comprising processing circuitry operable to:
transmit first power saving assistance information to a network node distributed unit (DU);
receive a configuration from a network node central unit (CU) associated to the network node DU, wherein the configuration is based at least in part on a portion of the first power saving assistance information that the DU forwarded to the CU.

10. The wireless device of claim 9, wherein the configuration is further based on information associated with the wireless device received at the CU from a core network node.

11. The wireless device of claim 10, wherein the information associated with the wireless device comprises one or more of subscription information associated with the wireless device, an expected behavior associated with the wireless device, and history information associated with the wireless device.

12. The wireless device of claim 9, wherein the first power saving assistance information comprises any one or more of:
a preferred synchronization signal block (SSB) configuration;
an indication of semi-statis uplink channel transmissions;
an indication of uplink buffer status;
a service priority;
a delay tolerance;
a data rate;
a data volume;
a traffic type;
a time criticality;
a packet size;
coverage information;
mobility status;
location information;
a preferred discontinuous reception configuration; and
a preferred antenna configuration.

13. The wireless device of claim 9, the processing circuitry further operable to transmit second power saving assistance information to the CU, and wherein the received configuration is based at least in part on a portion of the first power saving assistance information and the second power saving assistance information.

14. The wireless device of claim 13, wherein:
the first power saving assistance information comprises any one or more of:
a preferred synchronization signal block (SSB) configuration;
an indication of semi-statis uplink channel transmissions;
an indication of uplink buffer status;
a preferred antenna configuration; and
the second power saving assistance information comprises any one or more of:
a service priority;
a delay tolerance;
a data rate;
a data volume;
a traffic type;
a time criticality;
a packet size;
coverage information;
mobility status;
location information; and
a preferred discontinuous reception configuration.

15.-16. (canceled)

17. A method performed by a network node central unit (CU) operating with a split next generation radio access network (NG-RAN) architecture, the method comprising:
receiving first power saving assistance information associated with a first wireless device from a network node distributed unit (DU) associated with the first wireless device;
determining a power saving configuration for the network based at least in part on the first power saving assistance information; and
transmitting the power saving configuration to the DU.

18. The method of claim 17, further comprising receiving information associated with the first wireless device from a core network node, and wherein determining the power saving configuration is further based on the information associated with the first wireless device received from the core network node.

19. The method of claim 18, wherein the information associated with the first wireless device comprises one or more of subscription information associated with the first wireless device, an expected behavior associated with the first wireless device, and history information associated with the first wireless device.

20. The method of claim 17, wherein the first power saving assistance information comprises any one or more of:
a preferred synchronization signal block (SSB) configuration;
an indication of semi-statis uplink channel transmissions;
an indication of uplink buffer status;
a service priority;
a delay tolerance;
a data rate;
a data volume;
a traffic type;
a time criticality;
a packet size;
coverage information;
mobility status;
location information;
a preferred discontinuous reception configuration; and
a preferred antenna configuration.

21. The method of claim 17, further comprising receiving second power saving assistance information from the first wireless device, and wherein determining the power saving configuration is further based on the second power saving assistance information.

22. The method of claim 21, wherein:
the first power saving assistance information comprises any one or more of:
a preferred synchronization signal block (SSB) configuration;
an indication of semi-statis uplink channel transmissions;
an indication of uplink buffer status;
a preferred antenna configuration; and
the second power saving assistance information comprises any one or more of:
a service priority;
a delay tolerance;
a data rate;
a data volume;
a traffic type;
a time criticality;
a packet size;
coverage information;
mobility status;
location information; and
a preferred discontinuous reception configuration.

23. (canceled)

24. The method of claim 17, further comprising receiving third power saving assistance information from a second wireless device, and wherein determining the power saving configuration is further based on the third power saving assistance information.

25. A network node operating as a central unit (CU) with a split next generation radio access network (NG-RAN) architecture comprising processing circuitry, the processing circuitry operable to:
receive first power saving assistance information associated with a first wireless device from a network node distributed unit (DU) associated with the first wireless device;
determine a power saving configuration for the network based at least in part on the first power saving assistance information; and
transmit the power saving configuration to the DU.

26.-32. (canceled)

33. A method performed by a network node distributed unit (DU) operating with a split next generation radio access network (NG-RAN) architecture, the method comprising:
receiving first power saving assistance information associated with a first wireless device from the first wireless device;
transmitting a portion of the first power saving assistance information to a network node central unit (CU); and
receiving from the CU a power saving configuration for the network based at least in part on the first power saving assistance information.

34.-38. (canceled)

39. A network node operating as a distributed unit (DU) with a split next generation radio access network (NG-RAN) architecture comprising processing circuitry, the processing circuitry operable to:
receive first power saving assistance information associated with a first wireless device from the first wireless device;
transmit a portion of the first power saving assistance information to a network node central unit (CU); and
receive from the CU a power saving configuration for the network based at least in part on the first power saving assistance information.

40.-44. (canceled)
